(19) United States
(12) Patent Application Publication
(10) Pub. No.: US 2019/0378196 A1
(43) Pub. Date: Dec. 12, 2019

(54) METHOD AND DEVICE FOR PROVIDING IMAGE-BASED INFORMATION RELATED TO USER

(71) Applicant: Hyun Sung KO, Seoul (KR)

(72) Inventor: Hyun Sung KO, Seoul (KR)

(21) Appl. No.: 16/545,274

(22) Filed: Aug. 20, 2019

Related U.S. Application Data
(63) Continuation of application No. PCT/KR2018/000889, filed on Jan. 19, 2018.

(30) Foreign Application Priority Data
Feb. 21, 2017 (KR) 10-2017-0022654

(51) Int. Cl. G06Q 30/06; G06F 3/0482; G06K 9/00; G06Q 50/00; G06K 7/14; G06F 16/953

(52) U.S. Cl. CPC G06Q 30/0631; G06F 3/0482; G06K 9/00671; G06F 16/953; G06K 7/1413; G06K 7/1417; G06Q 50/01

(57) ABSTRACT

The present invention relates to a method and a device for providing image-based information related to a user through a network, and allows a client device to sense an image, extract information of at least one object from the sensed image, provide a user interface for receiving at least one user selection on the basis of the extracted information of the object, state information of the client device, and pre-stored user information, and perform network communication related to a user selection of at least one among the user interfaces when the selection is inputted, thereby maximizing user convenience.

### CROSS-REFERENCE TO RELATED APPLICATIONS

This application is a continuation application of PCT/KR2018/000889 filed on Jan. 19, 2018 which claims priority under 35 U.S.C. § 119 to Korean Patent Application No. 10-2017-0022654, filed on Feb. 21, 2017, the contents of which are herein incorporated by reference in their entireties.

### BACKGROUND

### 1. Field

Exemplary embodiments of the present inventive concept relate to a method of providing image-based information relating to the user over the network. More particularly, exemplary embodiments of the present inventive concept relate to a method of providing object information which is about the products existing in the image.

### 2. Description of the Related Art

People who promote products or services did not receive direct revenue from such promotions, and they promoted consumers to buy more directly by linking to their online store or by using hashtags. have.

However, if a general user using image-based social network services such as Instagram or Pinterest uploads a large number of photographs, the publicity of people promoting the goods or services may be hidden.

In the meantime, some users who have market promotion power through social network service or talents who have a wide network of people have played the role of promotion of specific companies through sponsorship or partnership agreement, but in this case, information about each product There was a hassle to write every time.

Moreover, since the tastes of the companies requesting the promotion are different, and the people who promote the promotion and the purchase intentions use different systems or applications, there is a cost and inconvenience in using different environments.

In addition, various companies requesting publicity, such as Amazon, G-Market, Wal-Mart, Costco, etc., had various incentive payment standards, and it was difficult to have a uniform form because of different kinds of products or services.

Most consumers use products or services from multiple companies at the same time. For example, one person may wear a Nike hat, an Adidas T-shirt, Louis Vuitton pants, Chanel socks, nameless slippers, stays in a hotel with an IKEA bed, and shops in Costco. In that, buyers may not be just buying one brand or manufacturer because they have their own tastes.

Using trends in which ordinary people are interested in photography and taking a lot of photos, there is a need for easy and simple methods to recommend various products to others, inform prospective buyers, and reward providers accordingly.

### SUMMARY

According to the present disclosure, when a user photographs an image of a product or the like, information of the product included in the image is extracted and provided to another person, wherein the information of the product may include producer information, seller information, and connection information about the user's shared service associated with the product.

According to the present disclosure, general consumers may be motivated to photograph an image of a product or the like. In detail, the present invention uses a database that provides a unique identification code for the product, so that users can obtain information about the products in a simple manner such as photographing to provide information related to the purchase to the third user.

According to the present disclosure, users may be provided with various services through simple photography to increase the user experience.

According to the present disclosure, the user may get or scan the object information by wireless communication. The object information includes object information for distribution, delivery, use purchase, etc. of the goods or services produced or proposed by the producer, and product identification information linked to.

According to the present disclosure, the user obtains one or more object information and he may propose a new product or a combination of goods to other users based on the object information.

### BRIEF DESCRIPTION OF THE DRAWINGS

The above and other features and advantages of the present inventive concept will become more apparent by describing in detailed exemplary embodiments thereof with reference to the accompanying drawings, in which:

FIG. 1a and 1b illustrate a flow chart for a method of providing image-based information according to an exemplary embodiment of the present inventive concept.

FIG. 2 illustrates a network configuration diagram for an image-based information providing method according to an exemplary embodiment of the present inventive concept.

FIGS. 3a to 3h illustrates a screen of a display device for photographing image and providing image-based information related to, according to an embodiment of the present invention,

FIG. 4 is a block diagram illustrating the configuration of a client device according to an embodiment of the present invention.

### DETAILED DESCRIPTION

The present inventive concept now will be described more fully hereinafter with reference to the accompanying drawings, in which exemplary embodiments of the present invention are shown. The present inventive concept may, however, be embodied in many different forms and should not be construed as limited to the exemplary embodiments set forth herein.

Rather, these exemplary embodiments are provided so that this disclosure will be thorough and complete, and will fully convey the scope of the present invention to those skilled in the art. Like reference numerals refer to like elements throughout.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular exemplary embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the inventive concept as used herein.

Hereinafter, the present inventive concept will be explained in detail with reference to the accompanying drawings.

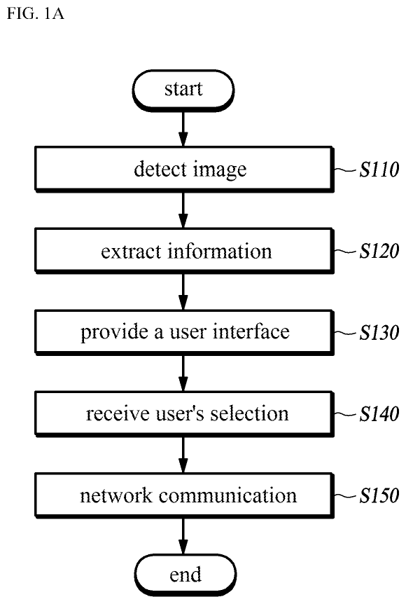

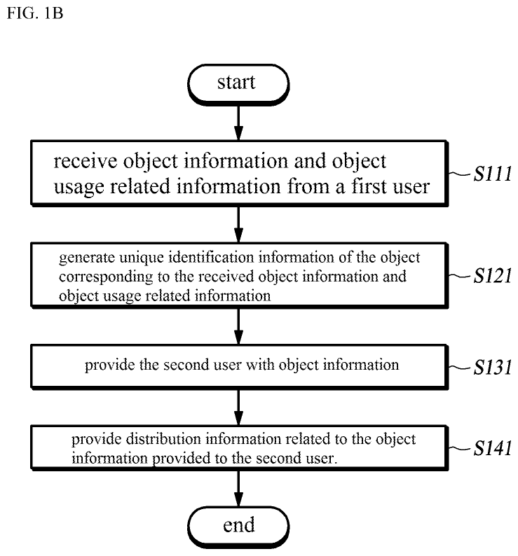

FIG. 1a and 1b illustrate a flow chart for a method of providing image-based information according to an exemplary embodiment of the present inventive concept.

In the present invention, the client device may be any device capable of receiving images over network, for example, a smartphone equipped with a camera device, a network camera, a tablet PC equipped with a camera device, a laptop computer, a user PC equipped with a webcam, and the like.

In step S110, the client device may detect an image when the image is taken to the photographing apparatus provided in the client device or when the image information is received and stored over the network.

In step S120, the client device may extract information of at least one object from the detected image. The object of the present invention may be any tangible commodity, intangible content, or the like that is sold and movable, and the object may be a unique object, such as an art object, a cultural asset, a creative item, a personality item or an item. In addition, the object may include any property, or intangibles that users can own, purchase, and experience, regardless of intangible services such as tourism products, content, restaurants, real estate, shopping malls, and performance venues.

The object information may include unique identification information such as an ID of the object. When the object is an industrial product or content, the unique identification information of the object may be unique information allocated to each object, such as barcode information and model number, which are generated when the factory is manufactured or produced. When the object is a real estate such as a restaurant or a tourist attraction, the object may be an address or location information for identifying the corresponding location.

The object information may include detailed information of the object. The detailed information of the object may include user information that is the subject of the action and information about the content of the action when the object is created, produced, distributed, or used or purchased by the user.

The object information may be managed in the code management system server of the present invention.

Extracting the object information includes receiving the object signal from some of the objects included in the image, extracting the unique identification information of the object from the received object signal, determining whether object corresponding to the unique identification information included the detected image. Details regarding the extraction of object information will be described later.

In step S130, the client device may provide a user interface for receiving a selection of at least one user based on the information of the extracted object, the device state information and the pre-stored user information.

The device state information may include a network connection state or running application information when the image detect. For example, when a user is using a social network service application, the device state information may be viewed as an application execution state of the corresponding social network service or a state of being connected with a social network service server over a network. As another example, when a user shops through the Internet, the device state information may be viewed as a shopping state connected to a corresponding online shopping site by a network. As another example, when a user is making a call, the device stats information may be viewed as being connected to another client device through a telephone communication network.

The stored user information may include unique information belonging to one user such as user ID, user delivery information, user payment information stored in the object management system server of the present invention or information for sale and purchase of the object. The user information may be stored in a storage medium of the client device or stored in the object management server of the present invention. In the latter case, the client device may receive user information and the like from the object management server to provide image-based information related to the user.

In addition, the user information may include information about an online shopping site that the user visited in the past through the client device, such as a list of sites and access information of the site. For example, if a user has signed up for Amazon or eBay and has visited the shopping site, site access information, such as the user's site login ID and login password, can be stored.

Meanwhile, the user information may include social network service information subscribed to and visited. For example, when a user has subscribed to Facebook or Instagram and visited through a client device, the user ID and password for accessing the corresponding social network service may be stored.

In addition, the user information may include search engine information visited by the user. If a user frequently uses a search engine such as Google or Yahoo through a client device, the search engine site information may be included. Meanwhile, the search engine information may include a search site related to the purchase or sale of the product, such as a site for comparing the price of the product and a lowest price search site.

That is, the user information in the present invention may be include personal information such as user ID, address, payment information or information for purchase and further include network connection records such as the online site records for the purchase, sale of goods through the client device and accessing social network services records for managing social networks or sharing information. The method in this invention encourages them to be exposed to services connected to objects in the image. To do this, a user interface for connecting to the network is provided in the next step.

In step S130, the user interface includes an interface for receiving a selection for connecting to at least one online shopping site associated with the stored user information. That is, when the user accesses the online shopping site through the client device, the interface is for accessing the shopping site.

The user interface includes an interface for receiving a selection for connecting to a social networking service associated with the stored user information. When a user accesses a social network service through a client device, the interface is for accessing the service.

The user interface includes an interface for receiving a selection for connection to a search engine associated with the stored user information. When a user accesses a specific search engine through a client device, the interface connects to the search engine.

The user interface includes an interface for receiving a selection for a connection to a website related to the information of the extracted object. For example, it may be a website managed by a producer or a distributor in order to promote or sell a corresponding object among the extracted object information.

When receiving a user's selection from at least one of the user interfaces in step S140, the network communication related to the selection is performed in step S150.

Hereinafter will be described in detail with respect to operations in the object management server and client device of the present invention with respect to the functions performed in FIGS. 1A and 1B.

FIG. 1B is a flowchart for a method of providing image-based information according to an embodiment of the present invention.

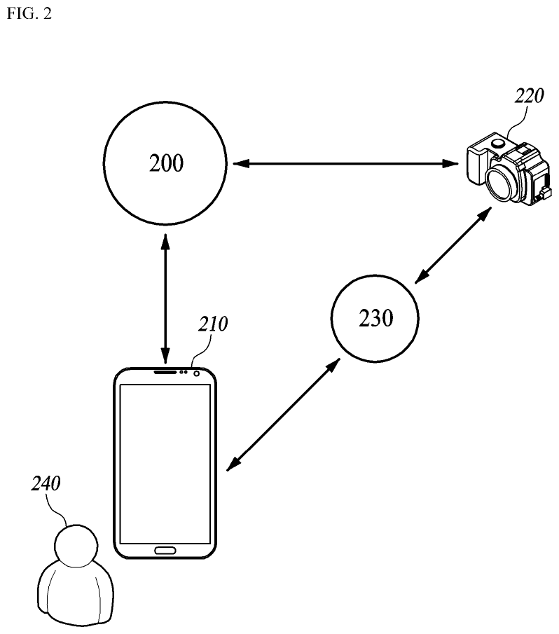

In Step S111, it receives object information and object usage related information from a first user. When the object of the present invention is a product, the first user may input object information related to the object when the product is initially produced or created. As shown in FIG. 2, the object information and the object usage related information may be input by the user 240 to the client device 210 of the present invention, and the information may be stored in the server 200. This allows the server 200 to provide the information second user when a second user requests the information.

The object information received from the first user may include at least one of code information including image IDs, image information, and text information. On the other hand, the object usage-related information received from the first user may include usage information of the object, for example, information on how to use video information, sales information, classification information, price information, payment information, distribution information, purchase information, location information. It may include at least one of path information, usage time information, sales information, the place of purchase, service information associated with the distribution. The path information related to distribution may include distributor delivery channels. In addition, the distribution information may include, for example, information about a production date, a production place, an initial price, etc. of the object when the first user 240 is the producer of the object.

On the other hand, when the information of the object and the object usage-related information is configured as code information, the corresponding code may be output in the form of an image. In addition, when the first user inputs object information and object usage related information for two or more objects, the information may be sequentially coded and stored in the server 200. That is, when object information and object usage related information are coded and stored for two or more objects, they may be stored as a structured list of objects. Object information and object usage related information of each object included in the list of objects may be stored in the order input by the first user. When there are a plurality of objects, the second user may select all or part of the objects, and the server may provide distribution information of the selected, so that the second user may apply to purchase all or some of the objects. In this case, the server 200 may extract distribution information of the requested object selected by the second user and provide the extracted distribution information to the second user.

In Step S121, it generates unique identification information of the object corresponding to the received object information and object usage related information. The unique identification information is information such as code information or ID for identifying an object, and may include at least one of a barcode, a label in which the code is formed in an image form, a QR code, and an Augmented Reality code. It may include one form and may include image-based information generated or recognizable by a predetermined identification means. For example, when the object is an industrial product or content, the unique identification information of the object may be unique information assigned to each object, such as barcode information and model number, which are generated when the factory is manufactured or produced. When the object is a real estate such as a restaurant or a tourist attraction, the object may be an address or location information for identifying the corresponding location.

On the other hand, the predetermined identification means may include any device or electronic tag or the like that can transmit or receive a radio signal or light. For example, the wireless signal may be a signal based on a wireless communication protocol such as Near Field Communication (NFC), Bluetooth, RFID, ZigBee, Beacon, Wi-Fi, or the like. Any device capable of transmitting or receiving light may be an optical sensor attached device capable of recognizing or transmitting light including information such as infrared communication, visible light communication, and the like.

In step S131, it provides the second user with object information through the identification information of the object. For example, a user interface or graphical user interface for providing information of an object is displayed and the first user and another second user view and select the information when the object including the object information and the object usage-related information. A graphic user interface may be provided through the display device.

In step S141, it provides distribution information related to the object information provided to the second user. The distribution information may include information related to at least one of sale, purchase, delivery, and payment information of the object, and may further include connection information through a network. That is, when the second user selects any one or more of the object information displayed on the display device, distribution information for connecting to the Internet site selling the object may be further provided in order to purchase or inquire the object. The Distribution information may include information such as reservation information for the purchase of an object, information about the object if it has a legal relationship with licenses or royalties, or ‘shopping carts’ in online sites that are reserved and stored in advance as a prerequisite for purchasing the object. Meanwhile, the distribution information may further include information for reselling the object to a third user who is not a second user, and in this case, further include payment or delivery information for resale of the object to the third user. The information may be disclosed to the Internet or a social network service, and third parties may provide the distribution information to the third user even when the third party inquires the information to purchase the object.

FIG. 2 illustrates a network configuration diagram for an image-based information providing method according to an exemplary embodiment of the present inventive concept.

Referring to FIG. 2, according to an embodiment of the present invention, the client devices 210 and 220 detect an image when capturing the object 230, extract information of at least one object from the detected image. The user interface may be provided on the client device for receiving the selection based on the information of the extracted object, the state information of the client device, and the previously stored user information in cooperation with the system server 200. Meanwhile, the client device may detect the image not only when the image is captured but also when the image information is received through the network.

On the other hand, when the object 230 transmits a wireless signal recognizable by the smartphone 210 or the camera 220, the smartphone 210 or the camera 220 receives an object signal, such as a wireless signal and they may extract the unique identification information of the object from the received object signal. The wireless signal transmitted from the object 230 is based on a wireless communication protocol such as Near Field Communication (NFC), Bluetooth, RFID, ZigBee, Beacon, Wi-Fi, or the like. May be a signal. The object 230 uses an active tag or an active tag to transmit a radio signal. In addition, the smartphone 210 or the camera 220 may include a wireless signal transmission/reception unit capable of recognizing a wireless signal from the object 230.

The client device 210, 220 for capturing the image including the object 230 compares the image information and the object signal received from the object 230 and may determine whether the image of the object that has sent a signal in the image information is exist. In detail, when the image of the object exists, the unique identification information of the object may be extracted from the corresponding radio signal, and the extracted unique identification information may be sent to the object management server 200 to request detailed information of the object. The object management server 200 has a database, stores information of the objects, and unique expressions of the objects when there is a request from the client devices 210, 220. In addition to the other information, detailed information of the object may be provided.

Unique identification information of the object and the detailed information of the object is stored and matched to the object management system server 200, the detailed information of the object information and the user of the user regarding the creation, production, distribution, experience or consumption of the object May contain some of the behavioral information.

Client devices 210 and 220 provided with detailed information of the object may include a user interface for receiving a selection of at least one user based on the extracted object information, the state information of the client device, and the stored user information. Client devices 210 and 220 may can display the user interface the provided screen.

In addition to the smartphone 210 or the camera 220 illustrated in FIG. 2, the client device of the present invention includes a wireless signal processing unit capable of recognizing a wireless signal from an object, and includes an imaging device such as a camera. It may be composed of any device such as a laptop, tablet PC, smart TV having a communication device that can communicate with the server 200 by Wi-Fi or the Internet.

The object management system server 200 may include a database (not shown) for storing the corresponding information in providing detailed information of the object, and receives a request for detailed information of the object from the devices 210 and 220. If all of the information is provided, or if the object is a sellable product, a part of the information may be provided as detailed information of the object as information related to the sale.

The database of the server 200 may be configured independently of the server may be operated through communication with the server or integrated into the server.

On the other hand, the server may further store information about the user. The user may vary according to the user classification information. Specifically, a user may be a creator who creates an object, a producer who manufactures and sells an object when the object is a tangible item such as a product, or a distributor who distributes an object from a producer or another user. In addition, the user may be a consumer who purchases, owns, and experiences an object, and inputs information about a late stage.

As such, the information input to the object according to the present invention may be composed of a combination of user identification information and user behavior information because the classification of the user to input the various. The user identification information may include a user unique ID, user classification information, and user detailed information. User identification information is managed and stored in the server 200.

The user unique ID may be information generated while the user enters the ID while the user registers the user in the code management system, and may be automatically generated unknowingly. For example, a unique serial number may be automatically generated according to time, place, and behavior information when a user first accesses the object management system server 200.

Next, an example of a method of providing image-based information relating to a user provided at a client device of the present invention is illustrated and described.

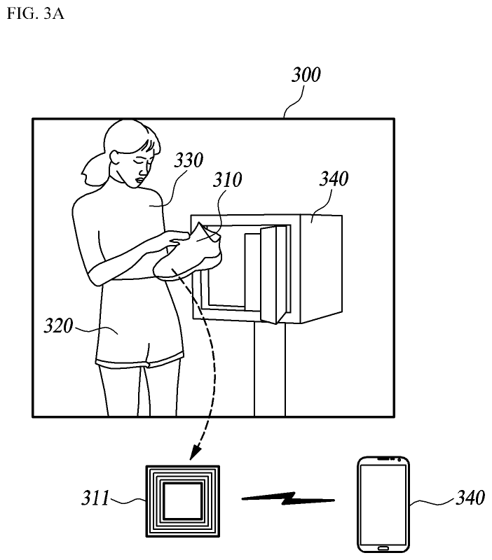

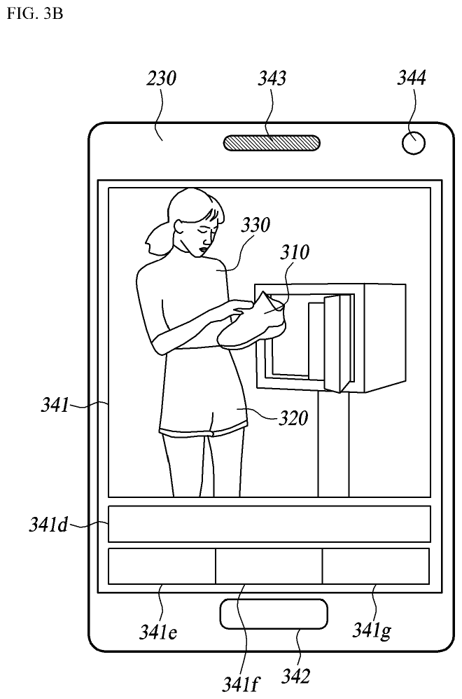

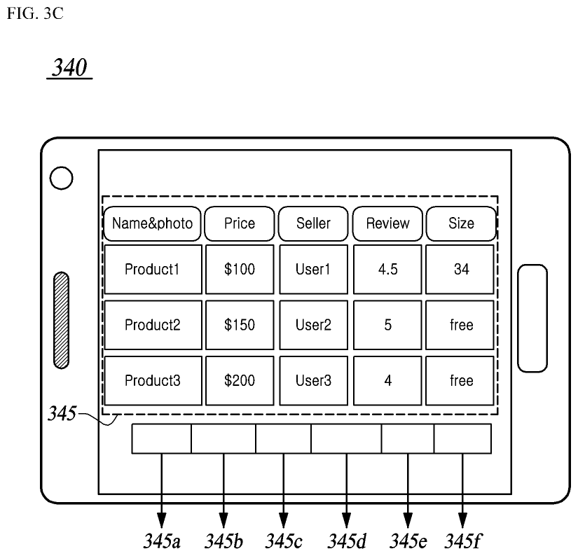

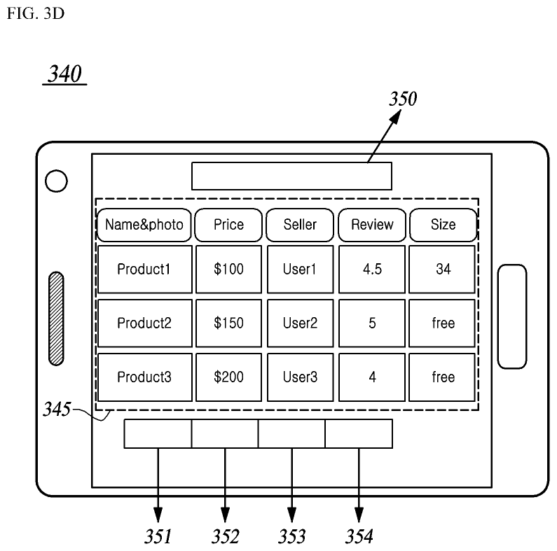

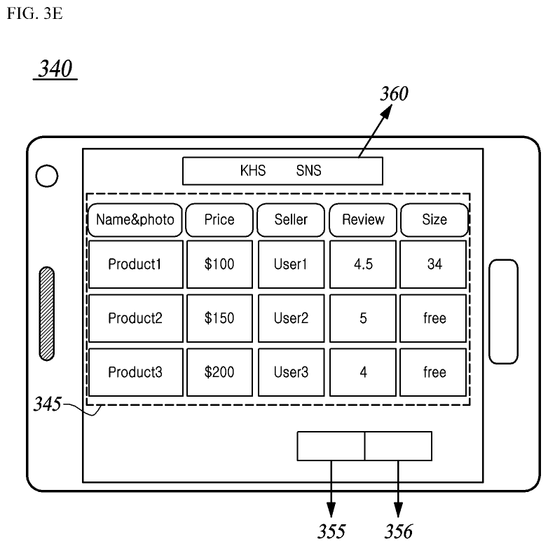

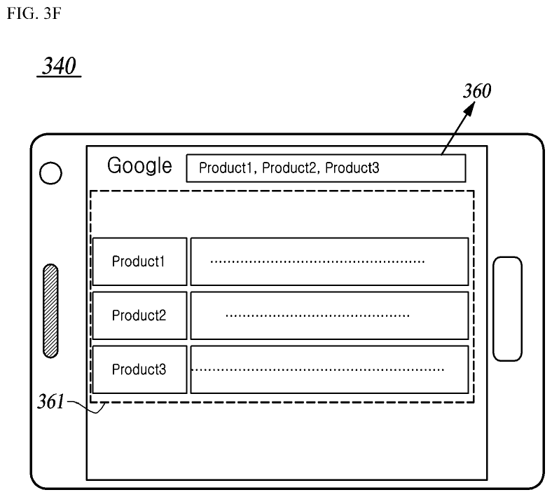

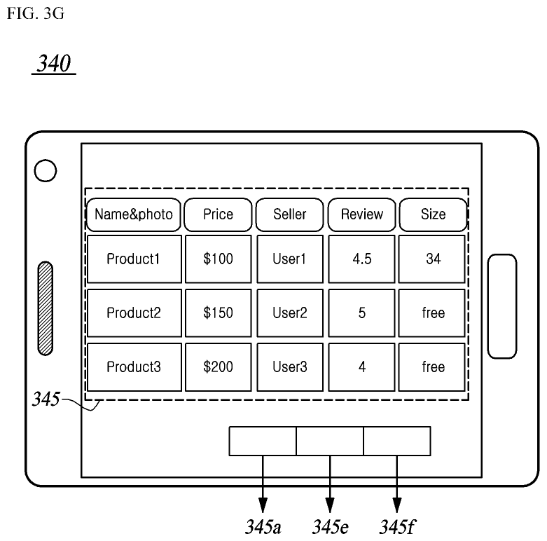

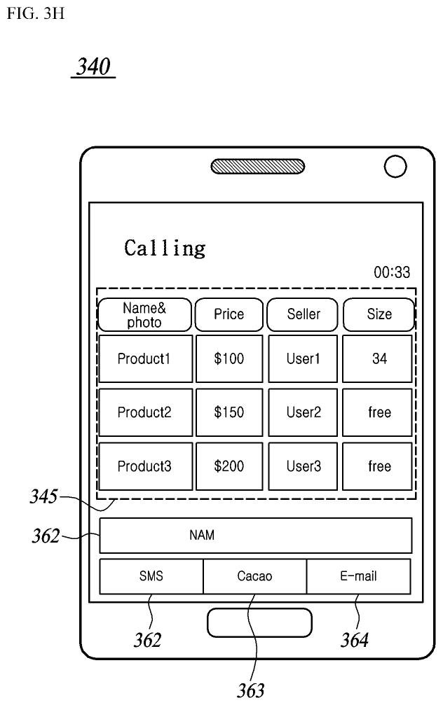

FIG. 3A to 3H illustrate screens of a display device for photographing images and providing image-based information related to, according to an embodiment of the present invention.

Referring to FIG. 3A, the smartphone 340 captures an image 300 including the objects 310, 320, and 330. Among the objects, the object 310 may include an electronic tag 311 that transmits a wireless signal and periodically transmit a wireless signal including unique identification information of the object, or may be transmitted under an event condition by the smartphone 340. The wireless signal is a signal based on a wireless communication protocol such as Near Field Communication (NFC), Bluetooth, RFID, ZigBee, Beacon, Wi-Fi, or the like. May be GPS, RFID, Infra-Red, or Ultrasonic sensor. For example, the smartphone 340 transmits a signal (Ack signal) for inducing a signal including the unique identification information by the object within a predetermined distance from the object, and transmits a signal including the unique identification information from the electronic tag 311 that detects the detected signal. The smartphone 340 may include an object signal processor that may receive and analyze a radio signal from the object 310, and may include an object signal analyzer that extracts unique identification information from the radio signal.

When the smartphone 340 captures the image 300, the smartphone 340 may detect an image and extract information on at least one object from the detected image. Also, it may be determined whether there is an image of the object in the corresponding image. For example, assume that there are three objects in the image 300 and that the object that transmits the radio signal is the shoe 310. In the smartphone 340, the relative position of the object that has transmitted the wireless signal may be analyzed with the direction and the strength of the corresponding wireless signal. In addition, it is possible to determine where the image of the object corresponding to the relative position exists in the image 300 to match the unique identification information of the object to the image. On the other hand, when the smartphone 340 compares and analyzes the image information and the relative position of the object, if the object that transmits the radio signal is determined not to be in the image information or the relative position and image information of the object is not matched, the image is retaken. For example, if a person receives a wireless signal from a sock (not shown) that is worn by the user, but there is no sock in the image 300, or some images are taken so that the socks are difficult to identify, the camera lens may be zoomed out or the angle of view may be reduced. It may be necessary to obtain another image that can identify the socks by adjusting. On the other hand, if there is more than a predetermined number of images of objects corresponding to the unique identification information of the objects extracted from the acquired information, it is difficult to provide all of the information of these objects to the display can be retaken in order to obtain the zoom-in image of the existing image again. That is, the rephotographed image may be a zoom in image or a zoom out image of the original image.

After the matching of the image information and the unique identification information of the object is completed, the smartphone 340 may request detailed information of the object matching the corresponding unique identification information to the object management system server of the present invention through the network. The unique identification information of the object and the detailed information of the object are matched and stored in the object management system server, and the detailed information of the object includes some of the user's information and user behavior information regarding the creation, production, distribution, experience or consumption of the object.

FIG. 3B illustrates an example of an object information screen 341 provided by the smartphone 340 which is a client device according to an embodiment of the present invention.

The smartphone 340 may display the information of the object received from the object management system server on the screen as shown in FIG. 3B. As shown in FIG. 3B, the part of image 310, 320, 330 and the number of objects 341d in the part of image of the object corresponding to the unique identification information extracted from the image may be displayed. In addition, FIG. 3B provides a search result 341d of an object, a selection command button 341e for inquiring the entire searched object, a cancel button 341f, and a button 341g for reacquiring image information. The button 341e is a button for inquiring all of the objects included in the acquired image. When the button 341e is selected, the entire object information may be displayed on a screen as shown in FIG. 3C.

Referring to FIG. 3C, the screen displays all information of all the objects such as the object name (name & photo), price, seller information, review average score, size, etc. When the user selects a part of the object, detailed information about the object may be further provided. Meanwhile, according to the present invention, the user interface 345a, 345b, 345c, or 345d may be provided to receive a selection of at least one user based on the extracted object information, the client device state information, and stored user information.

The user interface 345a may be an interface for receiving a selection for connection to a website related to the information of the extracted object. According to the present invention, when the extracted objects are promoted or sold on the online shopping site “11th street”, the interface 345a for connecting to a website managed by the distributor may be provided. When the user selects the interface 345a, the user can directly access the distribution site of the objects. Meanwhile, a site (not shown) managed by the creator of the object may be further provided as well as a site managed by the distributor.

In addition, the user interface 345a may be an interface for receiving a selection to connect to at least one online shopping site “11th street” associated with user information. For example, when the user has accessed the online shopping site through the client device and is registered, the connection information and the list of the site and the access information of the site may be included. For example, if a user has signed up for Amazon or eBay and has visited the shopping site, the user can store site access information such as the site login ID and login password, as well as the site address. User convenience may be enhanced by providing a connection interface 345a to the online shopping site related to the user information stored together with the object information based on the access information.

If the user selects the 345a, the user may automatically log in without using a user's cumbersome login procedure using previously stored site addresses and access information. Furthermore, as shown in FIG. 3D, an object information 345 may be provided, the object information 345 may be stored in a shopping cart of a shopping site, and an interface may be provided to directly make some purchases 352 and all purchases 353.

That is, according to the present invention, when a user photographs an image, the user is provided with list information and information of objects included in the image, and the user may select the online shopping site that is frequently accessed by the user and may directly access and log in. In addition, it is possible to provide a user interface for storing all objects in the object list, purchasing all objects, or purchasing some objects in a shopping site with a single click.

The user interface 345b may further include an interface for receiving a selection for connecting to a social networking service associated with the user information. In the present invention, the user information may include social network service information that the user has already subscribed to and visited. For example, when a user has subscribed to Facebook or Instagram and visited through a client device, the user ID and password for accessing the corresponding social network service may be stored. In addition, when the client device detects the image information and extracts the object information in the image, the interface 345b may be provided so that the client device may directly access and log in to the social networking service of the user who may share and transmit the object information. When the user selects the interface 345b, the user may access and log in to the social networking service of the user to post a list of corresponding object information as shown in FIG. 3E. When the user selects the interface 355 as shown in FIG. 3E, the object information 345 is posted to his social networking service.

In addition, the user interface 345c may be an interface for receiving a selection for connection to a search engine related to user information. If a user frequently uses a search engine such as Google through a client device, the search engine site information may be stored as user information, and an interface 345c for accessing the search engine site together with the object information 345 may be provided. When the user selects the interface 345c, the corresponding object information may be directly connected to a search engine to directly provide a search result for the object , as shown in FIG. 3F. That is, even if a user only shoots an image including an object through the client device, the user can provide information on the object inside the image and search the objects directly by a search engine that the user frequently used with a single click.

Meanwhile, the search engine may include a search site related to the purchase or sale of the product, such as a site for comparing the price of the product and a lowest price search site. You can access the search site and search for the price of an object. The lowest price search engine may store the subscription information or the access information and provide it as the user interface 345d when the user has previously subscribed or accessed through the client device.

Further, according to the present invention, a user interface may be provided based on state information of a client device, for example, network connection state, running application information, and call information at the time of detecting the image.

In addition, when the state information of the device is connected to a specific network, the user interface may be provided to input or transmit the object information through the connected network. When a user is connected to a specific shopping site, the object information can be retrieved or purchased from the shopping site. For example, when a user is connected to an online shopping site called “11th Street” and an image is detected, an interface may be provided as shown in FIG. 3G so that object information in the image is connected to a shopping site called 11th Street. When the user selects the interface 345a, the goods related to the object information may be listed and purchased or stored as shown in FIG. 3D.

When the state information of the device is running a specific application, a user interface based on the object information and the application may be provide. For example, when a user is using a social network service application and an image is detected, an interface for sharing the corresponding object information on the social network service may be provided as shown in FIG. 3E.

A user interface may be provided so that the state information of the device may share or transmit the object information connected to another user using a telephone communication network to the other user. For example, when a user is talking to a user named “NAM” and an image is detected and object information is included in the image, according to the present invention, various interfaces for transmitting the object information to “NAM” may be directly provided. As shown in FIG. 3H, User interfaces 362, 363, and 364 for Short Message Service (SMS), Social Network Service (SNS) or e-mail interface may be provided to a user named “NAM”, which may maximize the user convenience and experience.

That is, the present invention provides an interface to directly transmit or connect object information based on a state of a client device such as a call state, a call counterpart, or a network state as well as previously stored user information such as a site or a social network service that has been accessed in the past. By providing a smart service can be truly tailored to the user's intended intentions or future behavior.

Meanwhile, the user interface or the object information provided in FIGS. 3C to 3H may be displayed together with the image of FIG. 3B. Accordingly, other users who view the image may be provided with object information at the same time, thereby improving user convenience.

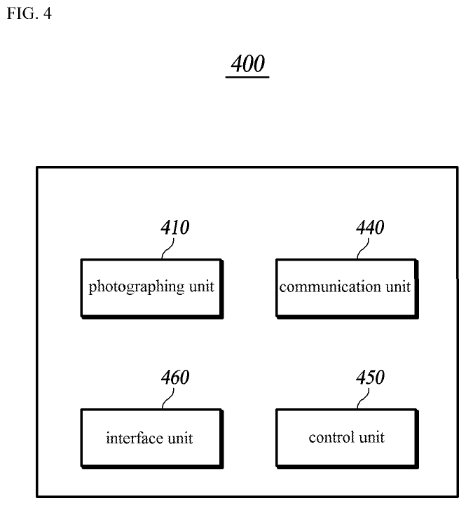

FIG. 4 is a block diagram illustrating the configuration of a client device according to an embodiment of the present invention.

The device for providing image-based information related to a user over a network may comprise a control unit 450, an interface unit 460 and communication unit 440.

The control unit 450 may detect an image, extract information of at least one object from the detected image, and provide a user interface displaying the extracted object information, state information of a client device, and stored user information which is for receiving a user selection. The control unit may provide object information and distribution information related to the object information to a second user. The distribution information includes information related to at least one of sale, purchase, delivery payment information, and connection information through a network of an object. The distribution information includes payment or delivery information for resale of the object to a third user who is not the second user. The distribution information allows the second user provide image-based information for use to the third user by publishing the distribution information to a social network service.

The control unit 450 may extract the unique identification information of the object, and determine whether there is an image of the object corresponding to the unique identification information of the extracted object from the acquired image information, and the unique identification information of the object.

The interface unit 460 may display a user interface by the control unit and receive a user's selection.

Then communication unit 440 may perform a network communication related to the selection.

The device may further include a photographing unit 410. The photographing unit may be configured to photograph an image, wherein the control unit detects an image when the photographing unit photographs and stores the image. The client device 400 according to an embodiment of the present invention receives an object signal from a photographing unit 410 for acquiring image information using a camera and at least one object existing within a predetermined distance and receives the object signal from the received object signal.

The scope of the present invention can also be applied to a program for the code information providing method of the present invention, a computer readable recording medium on which the program is recorded, an arbitrary electronic apparatus capable of executing the program.

The foregoing is illustrative of the present inventive concept and is not to be construed as limiting thereof. Although a few exemplary embodiments of the present inventive concept have been described, those skilled in the art will readily appreciate that many modifications are possible in the exemplary embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific exemplary embodiments disclosed, and that modifications to the disclosed exemplary embodiments, as well as other exemplary embodiments, are intended to be included within the scope of the appended claims. The present inventive concept is defined by the following claims, with equivalents of the claims to be included therein. In addition, the various technical features in the present inventive concept may be implemented by hardware, software, or a combination of hardware and software. Accordingly, a specific part of the method of analyzing the hazard of the control software driving system may be formed as at least one of computer programs executable by a general purpose microprocessor, a dedicated microprocessor and a microcontroller. The computer program according to the present exemplary embodiments may be stored in one of storing mediums including a non-volatile memory such as EPROM, EEPROM and a flash memory device, an internal hard disk and a detachable disk, a magnetic disk, a magneto optic disk and a CD disk. In addition, the program codes may be written in an assembly language or a machine language. The program codes may be transmitted by one of transmitting mediums including an electric wiring, a cable, and an optical fiber and so on.

What is claimed is:

1. A method for providing image-based information relating to a user over a network, performed by a computer, comprising:
receiving object information and object usage related information from a first user;
generating unique identification information of an object corresponding to the received object information and object usage related information; and
providing object information and distribution information related to the object information to a second user based on the unique identification information of the object,
wherein the distribution information includes information related to at least one of sale, purchase, delivery payment information, and connection information through a network of an object,
wherein the distribution information further includes payment or delivery information for resale of the object to a third user who is not the second user, and
wherein the distribution information allows the second user provide image-based information for use to the third user by publishing the distribution information to a social network service.

2. The method of claim 1, further comprising:
wherein the object information received from the first user includes at least one of code information, image information, and text information which includes object ID,
wherein the object usage related information received from the first user includes object usage information, sales information, classification information, price information, payment information, distribution information, purchase information, location information, path information related to distribution, and usage time information.

3. The method of claim 1, further comprising:
wherein the unique identification information is code information for identifying an object generated or recognizable by predetermined identification means such as a barcode, a label, a QR code, and an AR (Augmented Reality) code.

4. The method of claim 3, further comprising:
wherein predetermined identification means comprises any device capable of transmitting or receiving wireless signals or light.

5. The method of claim 1, further comprising:
where there is more than one object,
storing at least two object information and object usage related information in a server in a list form; and
providing distribution information on the selected object when the second user selects some of the objects.

6. A method for providing image-based information relating to a user over a network, performed by a computer, comprising:
detecting an image from client device and extracting at least one object information from the image;
providing a user interface displaying the extracted object information, state information of a client device, and previously stored user information which is for receiving a user selection; and
providing object information and distribution information associated with the object information to a second user;
wherein the distribution information includes information related to at least one of sale, purchase, delivery payment information, and connection information through a network of an object,
wherein the distribution information further includes payment or delivery information for resale of the object to a third user who is not the second user, and
wherein the distribution information allows the second user provide image-based information for use to the third user by publishing the distribution information to a social network service.

7. The method of claim 6, further comprising:
wherein the image is captured and stored by an image capturing apparatus included in the client device.

8. The method of claim 6, further comprising:
wherein the image is transmitted through a network.

9. The method of claim 6, further comprising:
the extracting of the object information may include receiving an object signal from some of objects included in the image and extracting unique identification information of the object from the received object signal.

10. The method of claim 6:
wherein the user interface includes an interface for receiving a user selection which is for connecting to at least one online shopping site associated with stored user information.

11. The method of claim 6:
wherein the user interface includes an interface for receiving a user selection which is for connecting to at least one social networking service associated with stored user information.

12. The method of claim 6:
wherein the user interface includes an interface for receiving a user selection which is for connecting to search engine associated with stored user information.

13. The method of claim 6:
wherein the user interface includes an interface for receiving a user selection which is for connecting to web-site associated with extracted object information.

14. The method of claim 6:
wherein the stored user information includes at least one of a user ID, user delivery information, and user payment information.

15. The method of claim 6:
wherein the stored user information includes information about an online shopping site that the user has visited in the past.

16. The method of claim 6:
wherein the stored user information includes social network service information that users subscribed to and visited.

17. The method of claim 6:
wherein the stored user information includes search engine information you have visited.

18. The method of claim 6:
wherein the state information includes network connection status and running application information when the image is detected.

19. A device for providing image-based information related to a user over a network, comprises:
a control unit detecting an image, extracting information of at least one object from the detected image, and providing a user interface displaying the extracted object information, state information of a client device, and previously stored user information which is for receiving a user selection;
an interface unit for displaying a user interface by the control unit and receiving a user's selection; and
a communication unit for performing a network communication related to the selection,
wherein the control unit provides object information and distribution information related to the object information to a second user,
wherein the distribution information includes information related to at least one of sale, purchase, delivery payment information, and connection information through a network of an object,
wherein the distribution information includes payment or delivery information for resale of the object to a third user who is not the second user, and
wherein the distribution information allows the second user provide image-based information for use to the third user by publishing the distribution information to a social network service.

20. The device of claim 19, further comprising:
a photographing unit configured to photograph an image, wherein the control unit detects an image when the photographing unit photographs and stores the image.
